(19) United States
(12) Patent Application Publication
(10) Pub. No.: US 2018/0369074 A1
(43) Pub. Date: Dec. 27, 2018

(54) TEETHER HAVING HANDLES SURROUNDING A CONCAVE INTERIOR

(71) Applicant: Live-Right, LLC, Idaho Falls, ID (US)

(72) Inventors: Troy Tegeder, Winchester, CA (US); Charles Phillips, Sandy, UT (US); Aaron Nelson, Salt Lake City, UT (US); Anne Phillips, Sandy, UT (US)

(21) Appl. No.: 15/729,390

(22) Filed: Oct. 10, 2017

Related U.S. Application Data
(63) Continuation of application No. 29/609,010, filed on Jun. 27, 2017.
Application No. 29/609,010 is a continuation of application No. 29/618,341, filed on Sep. 20, 2017.
Application No. 29/618,341 is a continuation of application No. 29/618,558, filed on Sep. 21, 2017.

(51) Int. Cl. A61J 17/02

(52) U.S. Cl. CPC A61J 17/02

(57) ABSTRACT

Teethers are configured with a base, a biting structure that extends distally from the base, and one or more handles that extend proximally from the base. The base has a hollow interior with both a proximal opening and a distal opening. The biting structure is also hollow and includes a proximal opening such that the biting structure has a proximally-facing concave interior. As a result of this design, a baby may use the teether by either grasping the one or more handles or by inserting his or her fingers through the base and into the concave interior of the biting structure. With the baby's fingers inserted into the concave interior of the biting structure, the baby can satisfy the desire to insert his or her fingers into the mouth while also biting on the teether.

### CROSS-REFERENCE TO RELATED APPLICATIONS

This application is a continuation of U.S. Design Patent Application No: 29/609,010 which was filed on Jun. 27, 2017.

This application is also a continuation of U.S. Design Patent Application No: 29/618,341 which was filed on Sep. 20, 2017.

This application is also a continuation of U.S. Design Patent Application No: 29/618,558 which was filed on Sep. 21, 2017.

### BACKGROUND

A teether is an object that is designed for a baby to bite on. As its name implies, a teether is typically intended to provide comfort and relief during teething. Teethers are commonly designed with a ring shape to allow the baby to hold one side of the teether while biting on the other.

### BRIEF SUMMARY

The present invention extends to teethers having a base, a biting structure that extends distally from the base, and one or more handles that extend proximally from the base. The base has a hollow interior with both a proximal opening and a distal opening. The biting structure is also hollow and includes a proximal opening such that the biting structure has a proximally-facing concave interior. As a result of this design, a baby may use the teether by either grasping the one or more handles or by inserting his or her fingers through the base and into the concave interior of the biting structure. With the baby's fingers inserted into the concave interior of the biting structure, the baby can satisfy the desire to insert his or her fingers into the mouth while also biting on the teether.

In one embodiment, the present invention is implemented as a teether that includes: a base having a proximal end and a distal end, the base having a hollow interior such that the proximal and distal ends of the base form openings into the hollow interior; a biting structure that extends distally from the proximal end of the base, the biting structure having a proximal end coupled to the distal end of the base and an enclosed distal end, the biting structure forming a proximally-facing concave interior that is accessible via the hollow interior of the base; and one or more handles that extend proximally from the proximal end of the base, each handle forming an opening by which the hollow interior of the base is accessible.

In another embodiment, the present invention is implemented as a teether that includes: a base having a hollow interior; a biting structure that extends distally from the base, the biting structure forming a proximally-facing concave interior, the biting structure having an outer surface that is configured in the shape of a fruit; and handles that extend proximally from the base, each handle forming an opening between the handle and a proximal end of the base by which the hollow interior of the base is accessible, the handles being configured to form an additional opening between the handles by which the hollow interior of the base is also accessible.

In another embodiment, the present invention is implemented as a teether that includes: a base having a proximal end, a distal end and a hollow interior, an outer surface of the base being configured to resemble foliage; a biting structure that extends distally from the proximal end of the base, the biting structure forming a proximally-facing concave interior that is accessible via the hollow interior of the base, an outer surface of the biting structure being configured to resemble a fruit; and one or more handles that extend proximally from the proximal end of the base.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1A is a front perspective view of an embodiment of a teether that is configured to resemble a strawberry;

FIGS. 1B and 1C are front and rear views respectively of the teether of FIG. 1A;

FIGS. 1D and 1E are right and left side views respectively of the teether of FIG. 1A;

FIGS. 1F and 1G are top and bottom views respectively of the teether of FIG. 1A;

FIG. 1H is a cross-sectional front view of the teether of FIG. 1A;

FIG. 2A is a front perspective view of an embodiment of a teether that is configured to resemble a pineapple;

FIGS. 2B and 2C are front and rear views respectively of the teether of FIG. 2A;

FIGS. 2D and 2E are right and left side views respectively of the teether of FIG. 2A;

FIGS. 2F and 2G are top and bottom views respectively of the teether of FIG. 2A;

FIG. 2H is a cross-sectional front view of the teether of FIG. 2A;

FIG. 3A is a front perspective view of an embodiment of a teether that is configured to resemble a bunch of grapes;

FIGS. 3B and 3C are front and rear views respectively of the teether of FIG. 3A;

FIGS. 3D and 3E are right and left side views respectively of the teether of FIG. 3A;

FIGS. 3F and 3G are top and bottom views respectively of the teether of FIG. 3A; and

FIG. 3H is a cross-sectional front view of the teether of FIG. 2A.

### DETAILED DESCRIPTION

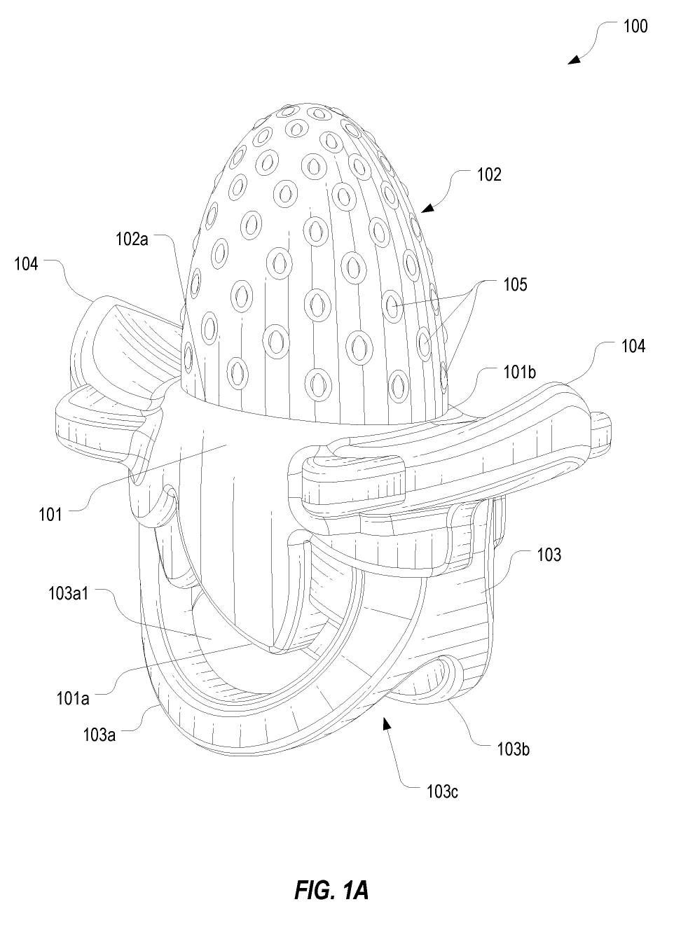

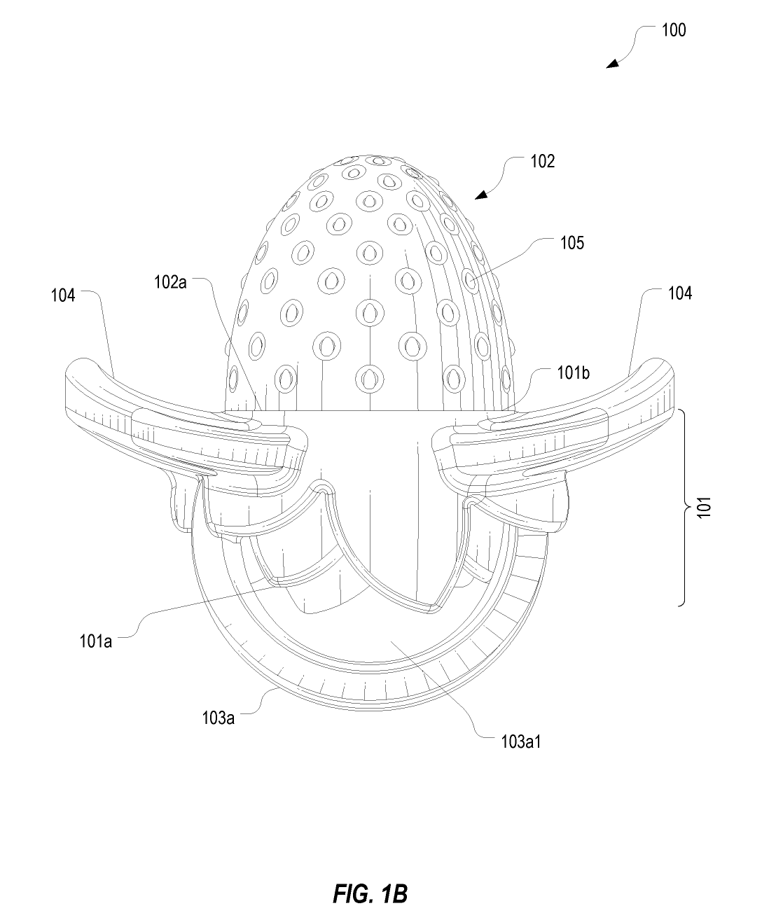

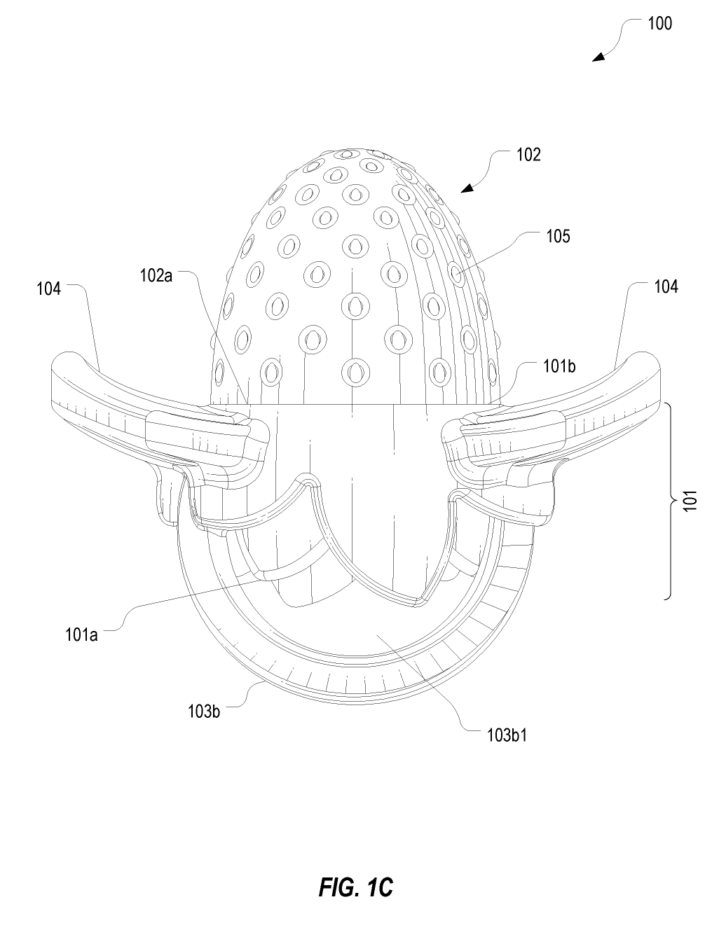

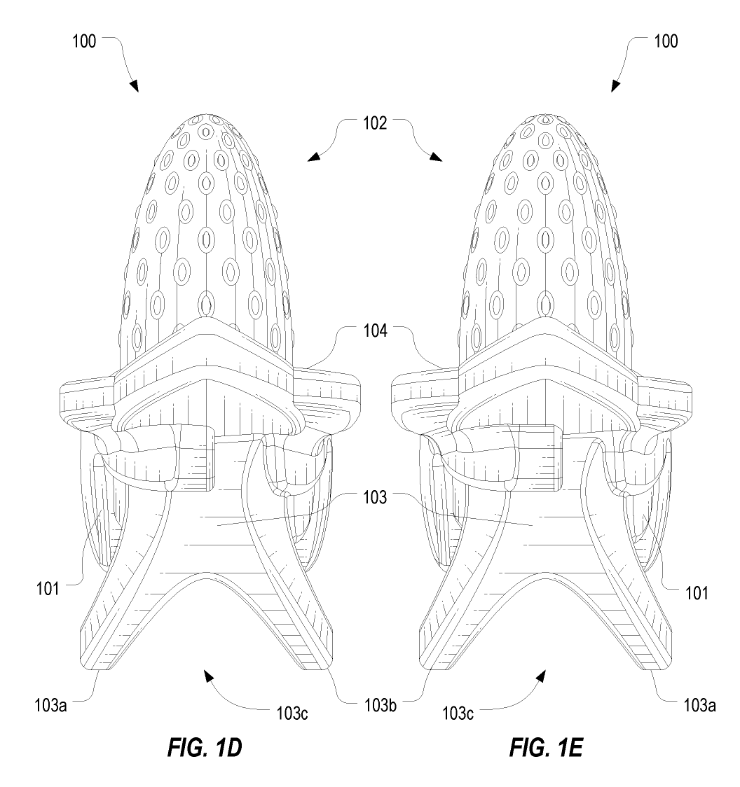

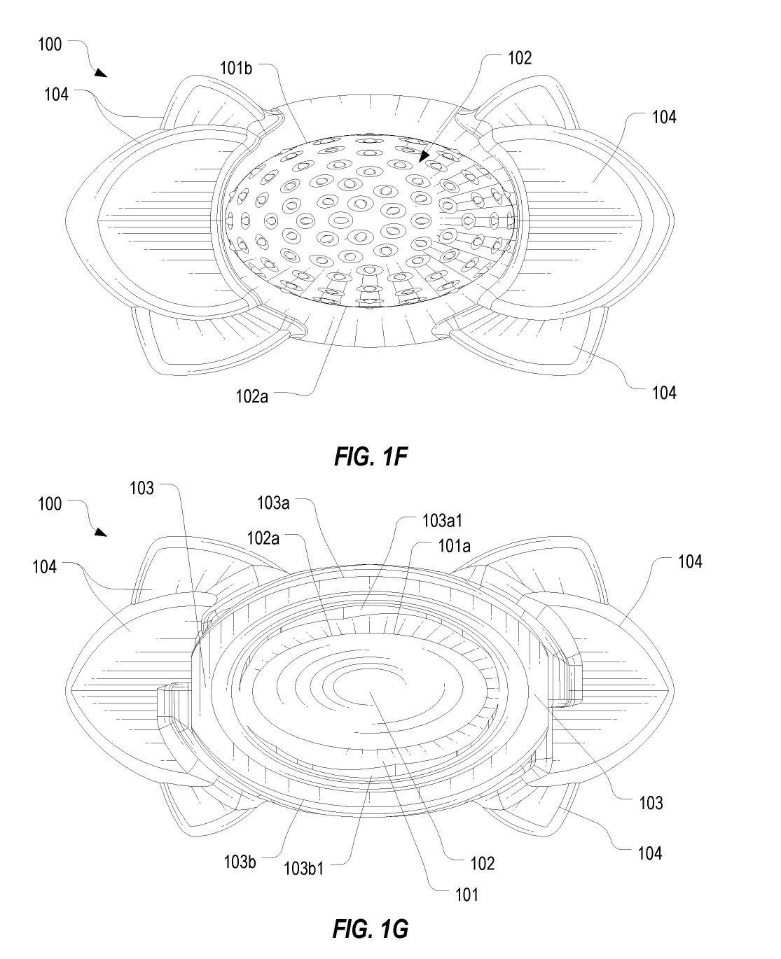

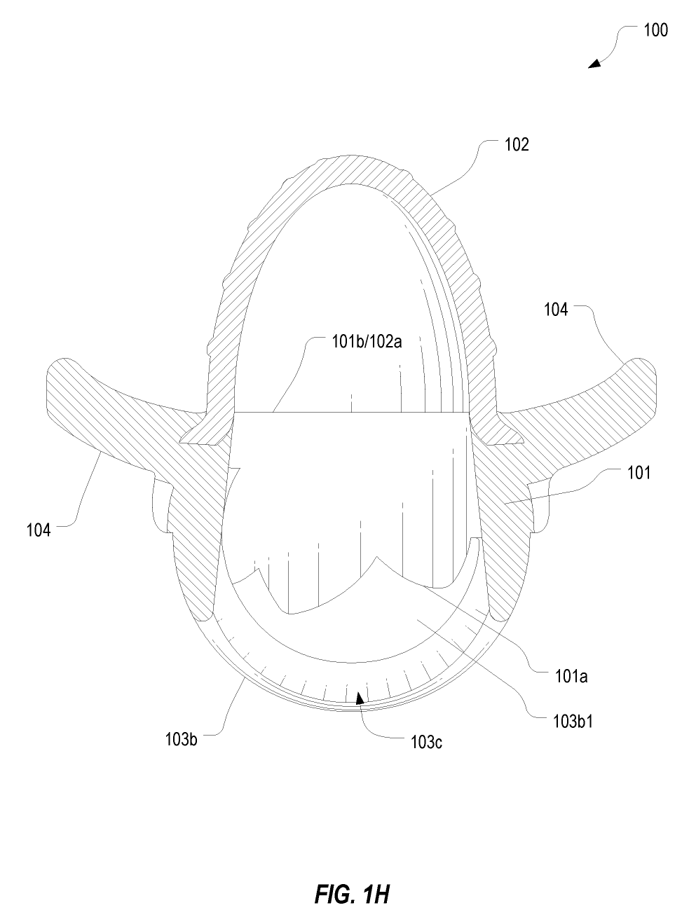

FIGS. 1A-1H, 2A-2H, and 3A-3H each depict an embodiment of a teether that is configured in accordance with the present invention. In each embodiment, the teether is configured to resemble a fruit, namely, a strawberry, a pineapple, and grapes respectively. In these embodiments, the biting structure of the teether forms the fruit while the base of the teether forms the fruit's foliage.

In this specification and the claims, proximal will be used to refer to the end of the teether where the base and handles are formed while distal will be used to refer to the opposing end of the teether where the fruit is formed. Accordingly, the biting structure of a teether extends distally from the base while the handles extend proximally from the base.

FIGS. 1A-1H illustrate various views of a teether 100 that resembles a strawberry and is configured in accordance with embodiments of the present invention. Teether 100 includes a base 101, a biting structure 102 that extends distally from base 101 to form an enclosed distal end of teether 100, and handles 103a, 103b that extend proximally from base 101. Base 101 includes a proximal end 101a and a distal end 101b and is configured with a hollow interior such that proximal end 101a and distal end 101b both form openings into the hollow interior.

Biting structure 102 includes a proximal end 102a that couples to distal end 101b of base 101. Biting structure 102 is also hollow but has an enclosed distal end such that proximal end 102a provides access to a proximally-facing concave interior. As is best shown in FIG. 1H, the hollow interiors of base 101 and biting structure 102 form a cavity into which a baby (or other individual) may insert his or her fingers. The combination of the hollow interiors of base 101 and biting structure 102 will therefore allow a baby to insert biting structure 102 into his or her mouth while having his or her fingers inserted into the hollow interior of teether 100. This may simultaneously satisfy the baby's urges to bite on something and insert his or her fingers in the mouth. In some embodiments, the outer surface of biting structure 102 may include spaced protrusions 105 to form a texture on the biting surface as well as to resemble seeds of a strawberry. These seed-resembling protrusions 105 can enhance the comfort provided by teether 100.

Teether 100 also includes handles 103a, 103b that extend proximally from opposing sides (e.g., front and back sides) of base 101. The corresponding ends of handles 103a, 103b emanate from a common base extension 103 but extend proximally away from base 101 to form openings 103a1, 103b1 on opposing sides of base 101. Accordingly, proximal end 101a of base 101 is accessible via openings 103a1, 103b1 and via an opening 103c formed between handles 103a, 103b. Openings 103a1, 103b1, and 103c enable a baby to easily grasp teether 100 via handles 103a, 103b while also providing access into the hollow interior formed by base 101 and biting structure 102.

Base 101 can also include a number of extensions 104 that protrude primarily in a lateral direction from base 101 but may also or alternatively protrude in a frontward or rearward direction. In some embodiments, each extension 104 can emanate from base 101 while in other embodiments, one or more extensions 104 may at least partially emanate from another extension 104.

Extensions 104 can function as a structure to prevent over-insertion of teether 100 into a baby's mouth and as supplemental biting structures. In the depicted embodiment, multiple extensions emanate from each side of base 101 and are configured to resemble leaves of a strawberry.

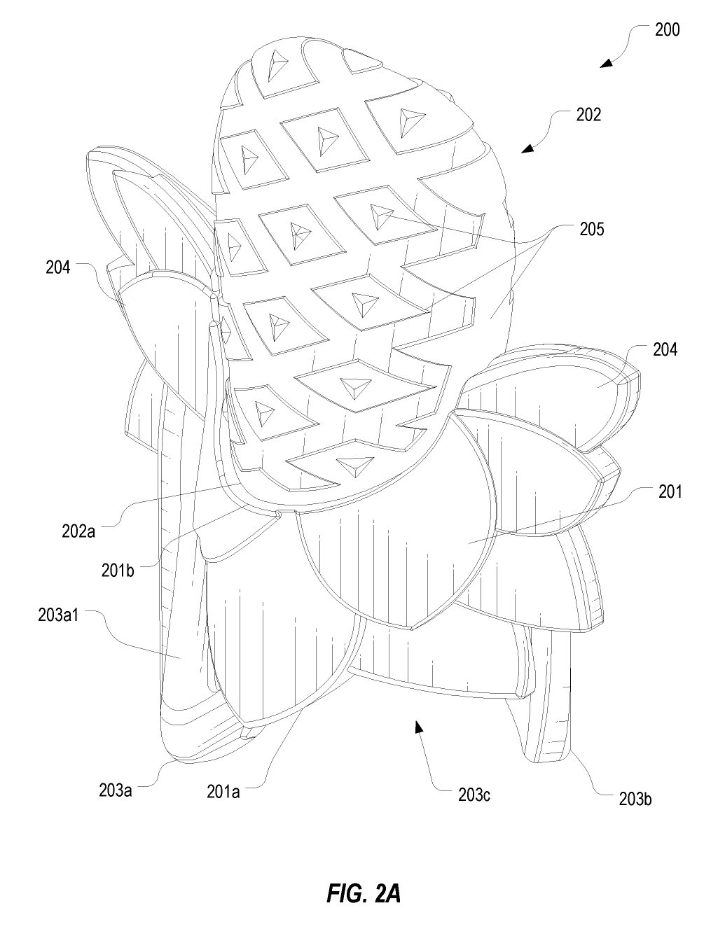

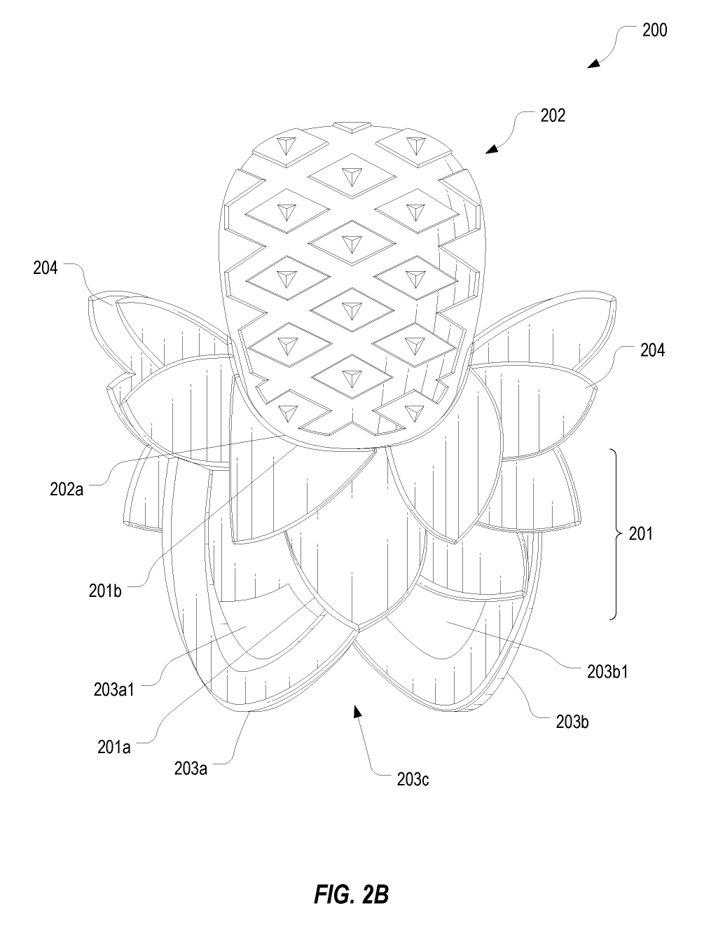

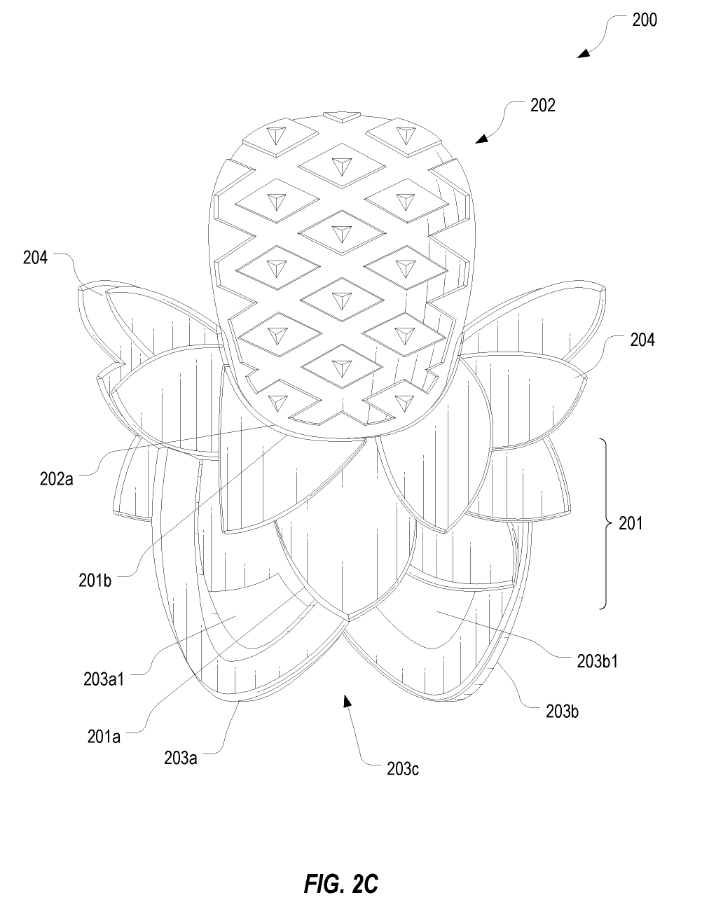

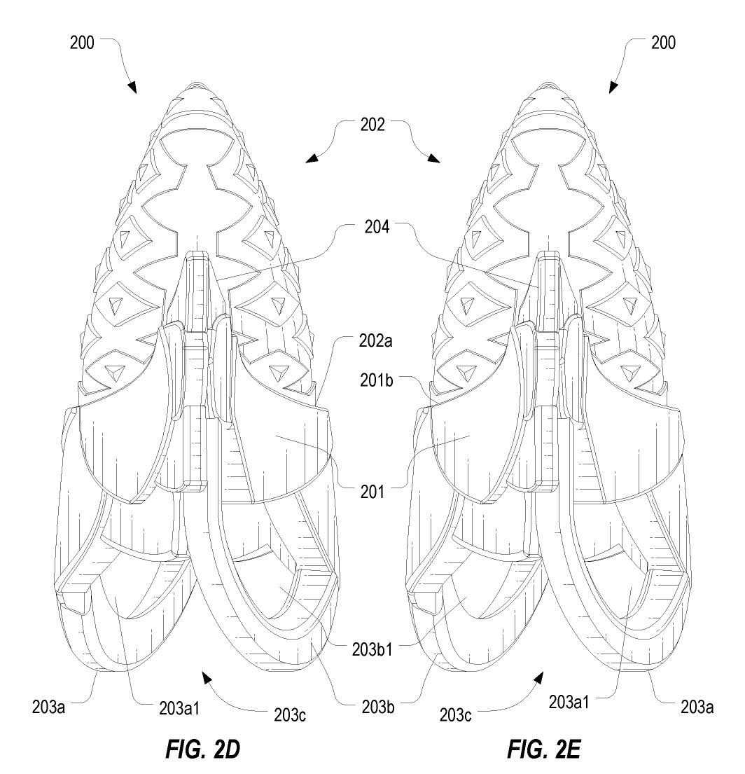

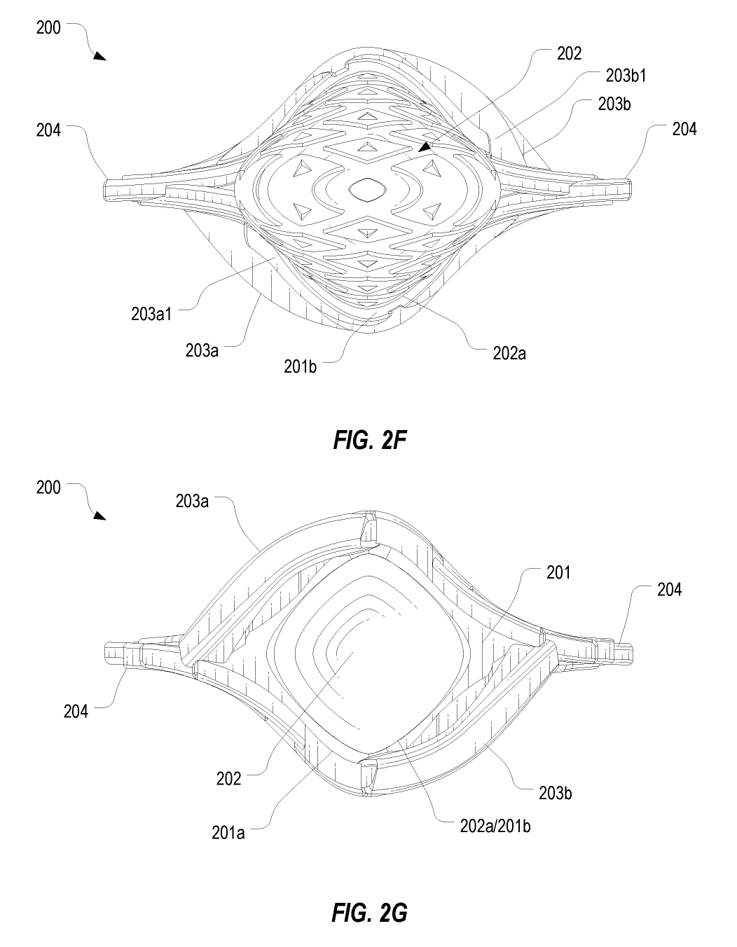

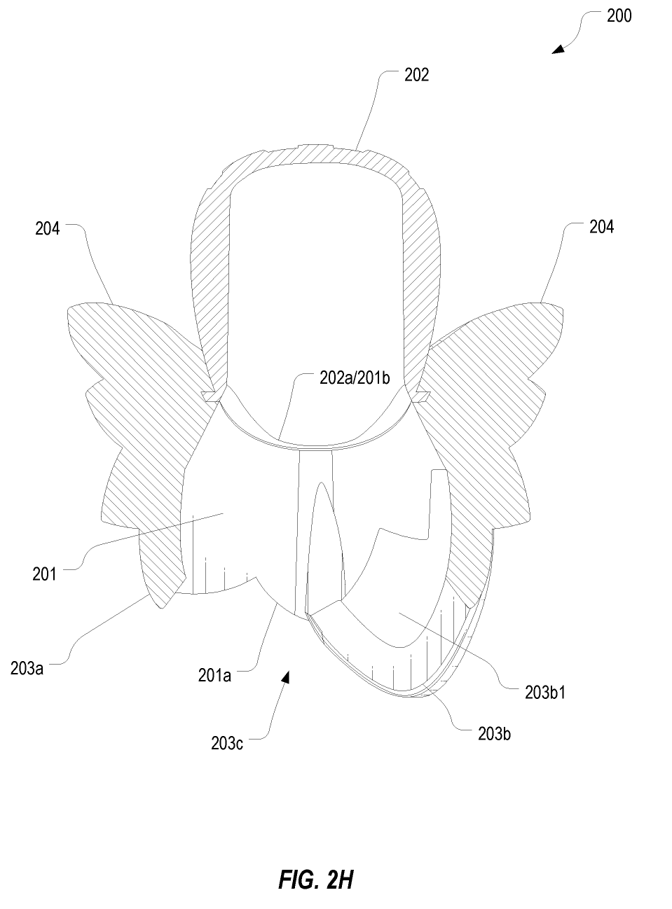

FIGS. 2A-2H illustrate various views of a teether 200 that resembles a pineapple and is configured in accordance with embodiments of the present invention. Teether 200 includes a base 201, a biting structure 202 that extends distally from base 201 to form an enclosed distal end of teether 200, and handles 203a, 203b that extend proximally from base 201. Base 201 includes a proximal end 201a and a distal end 201b and is configured with a hollow interior such that proximal end 201a and distal end 201b both form openings into the hollow interior.

Biting structure 202 includes a proximal end 202a that couples to distal end 201b of base 201. Biting structure 202 is also hollow but has an enclosed distal end such that proximal end 202a provides access to a proximally-facing concave interior. As with teether 100, the hollow interiors of base 201 and biting structure 202 form a cavity into which a baby may insert his or her fingers. In some embodiments, the outer surface of biting structure 202 may include spaced protrusions 205 to form a texture on the biting surface that resembles the texture of a pineapple.

Teether 200 also includes handles 203a, 203b that extend proximally from opposing sides (e.g., front and back sides) of base 201. Unlike handles 103a, 103b which emanate from a common base extension 103, handles 203a, 203b each extend from an opposing side and terminate towards the middle of base 201. Therefore, each handle 203a, 203b is offset towards the left of the corresponding front or back of teether 202. Each handle 203a, 203b forms an opening 203a1, 203b1 respectively through which proximal end 201a of base 201 is accessible. An opening 203c is also formed between handles 203a, 203b. As is best seen in FIG. 2G, opening 203c extends from a front to a rear of base 201 between handles 203a, 203b. Openings 203a1, 203b1, and 203c enable a baby to easily grasp teether 200 via handles 203a, 203b while also providing access into the hollow interior formed by base 201 and biting structure 202.

Base 201 can also include a number of extensions 204 similar to extension 104. In particular, extensions 204 can function as a structure to prevent over-insertion of teether 200 into a baby's mouth and as supplemental biting structures. In the depicted embodiment, extensions 204 are configured to resemble leaves of a pineapple plant. Teether 200 can otherwise be configured in the same or similar manner as described above for teether 100.

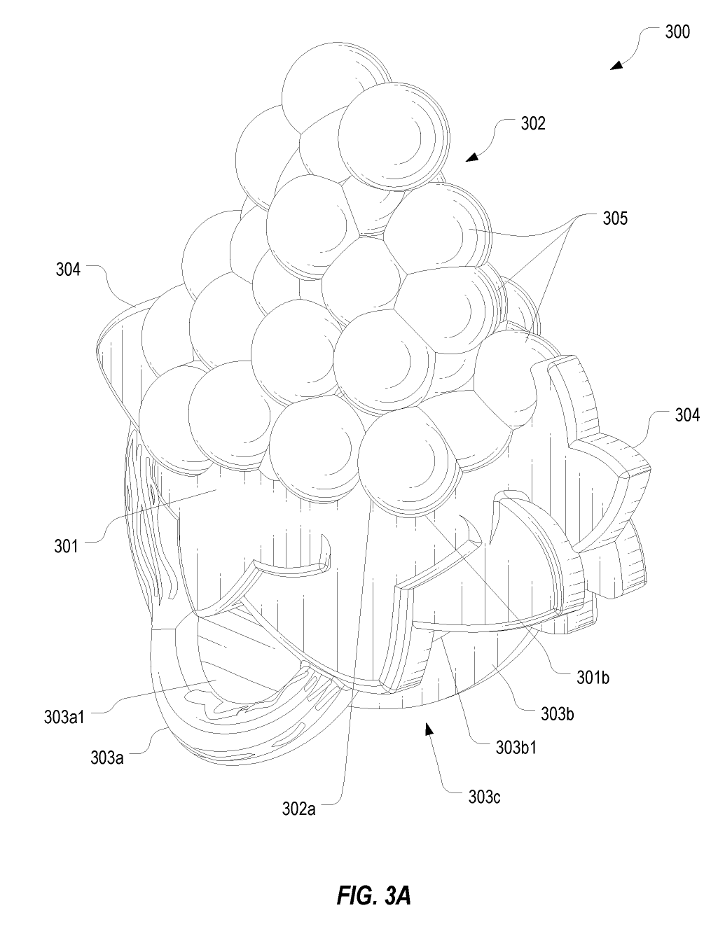

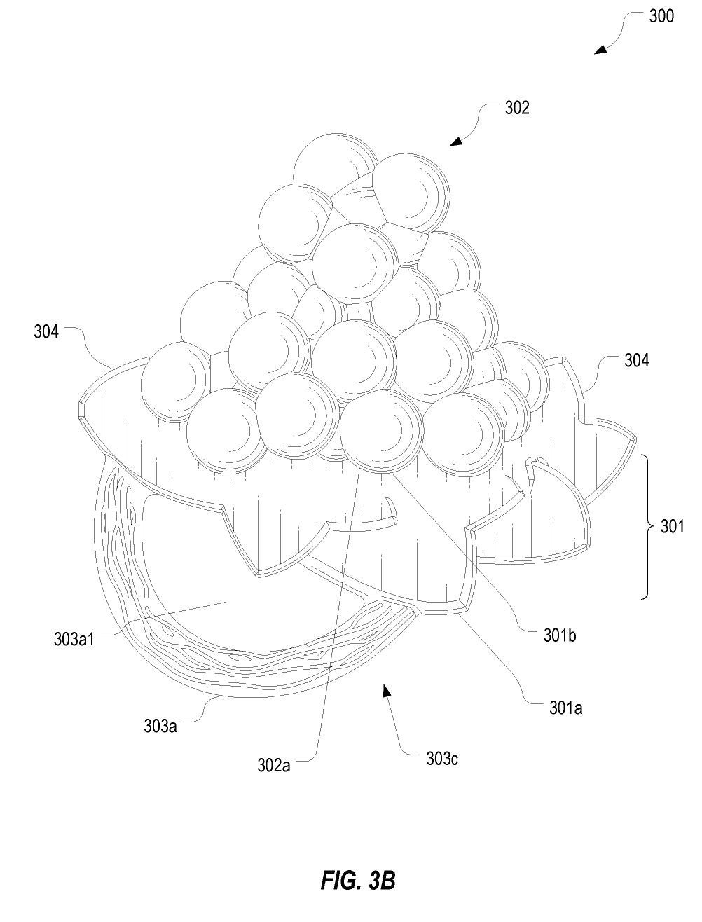

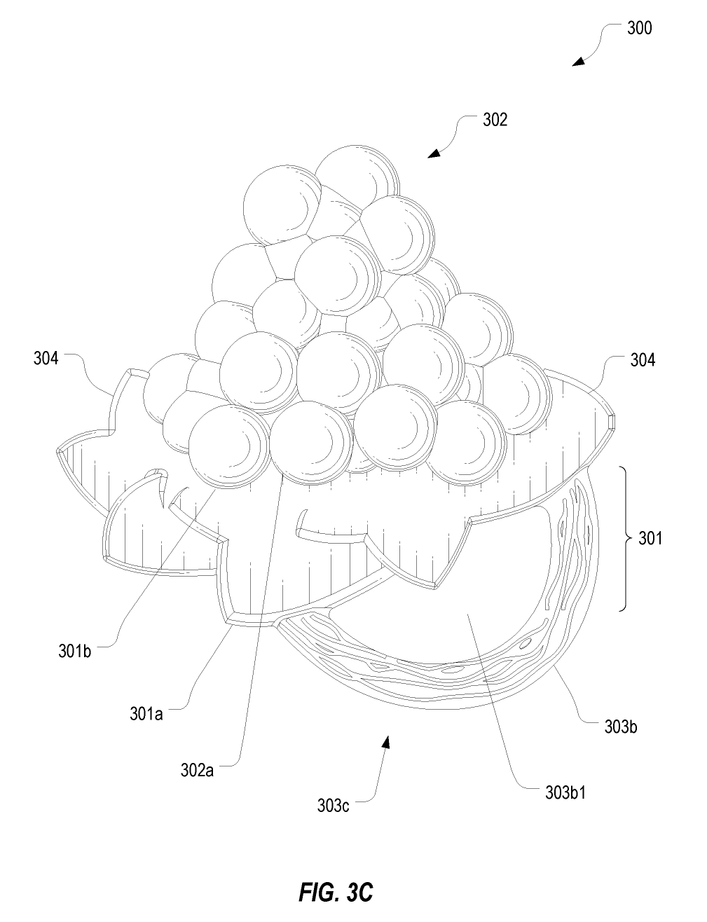

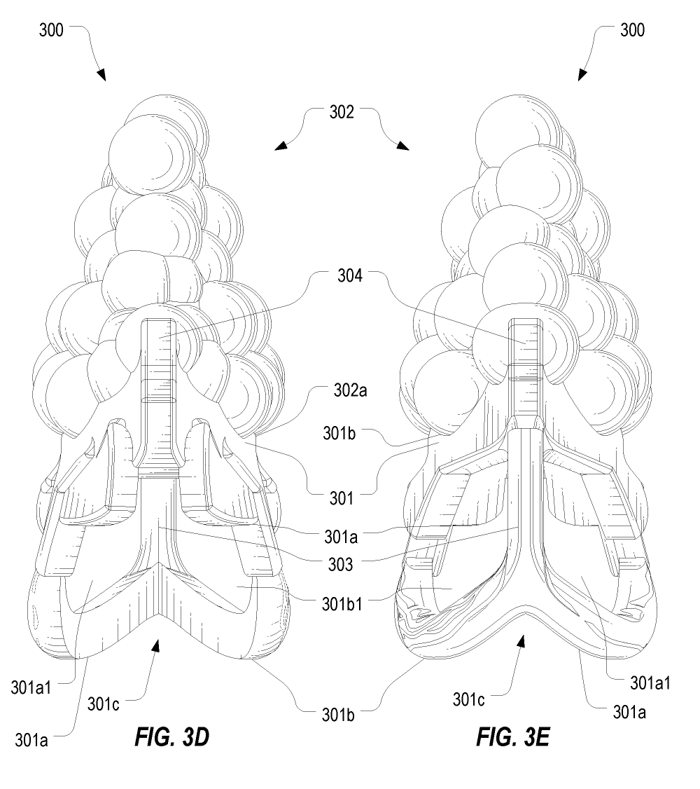

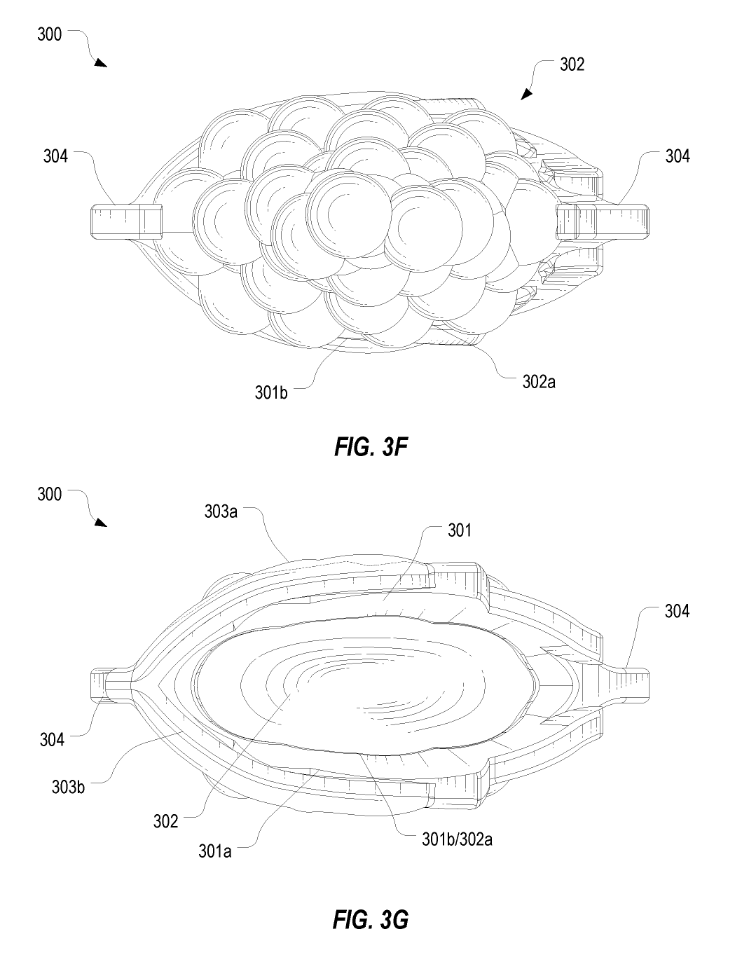

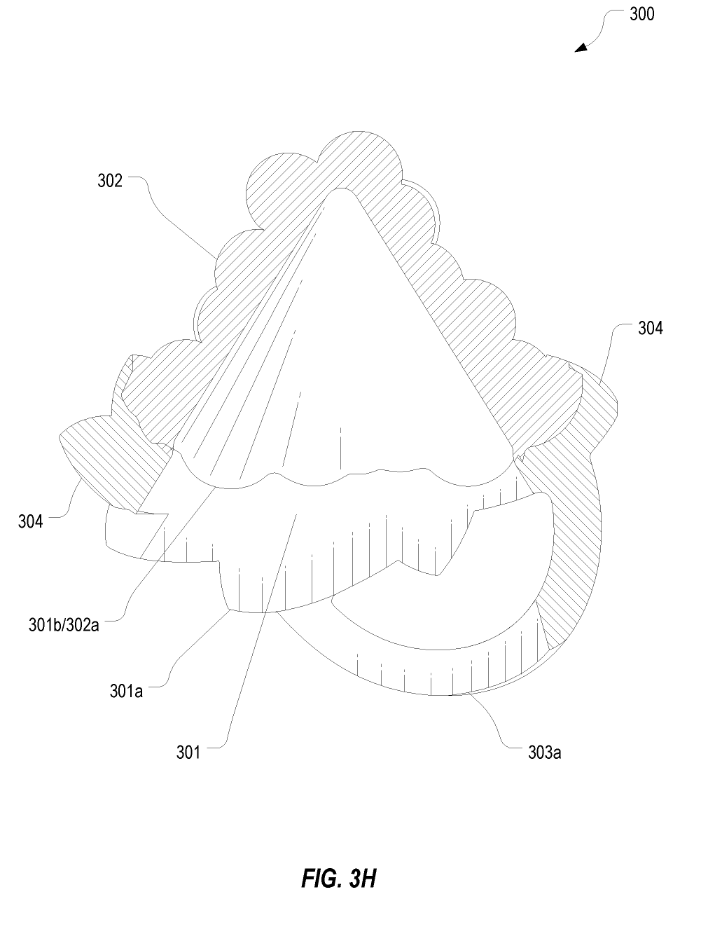

FIGS. 3A-3H illustrate various views of a teether 300 that resembles a bunch of grapes and is configured in accordance with embodiments of the present invention. Teether 300 includes a base 301, a biting structure 302 that extends distally from base 301 to form an enclosed distal end of teether 300, and handles 303a, 303b that extend proximally from base 301. Base 301 includes a proximal end 301a and a distal end 301b and is configured with a hollow interior such that proximal end 301a and distal end 301b both form openings into the hollow interior.

Biting structure 302 includes a proximal end 302a that couples to distal end 301b of base 301. Biting structure 302 is also hollow but has an enclosed distal end such that proximal end 302a provides access to a proximally-facing concave interior. As with teethers 100 and 200, the hollow interiors of base 301 and biting structure 302 form a cavity into which a baby may insert his or her fingers. The outer surface of biting structure 302 may be contoured with protrusions 305 to form a texture on the biting surface that resembles a bunch of grapes.

Teether 300 also includes handles 303a, 303b that extend proximally from opposing sides (e.g., front and back sides) of base 301. One side of each handle 303a, 303b emanates from a common base extension 303 while the opposite side of each handle 303a, 303b extends to a middle portion of the corresponding front or rear of base 301. Each handle 303a, 303b therefore is in alignment on one side of teether 300. Handles 303a, 303b may include a texture to facilitate gripping. Although not shown in the figures, handles 103a, 103b, 203a, 203b could also include a similar texture.

Each handle 303a, 303b forms an opening 303a1, 303b1 respectively through which proximal end 301a of base 301 is accessible. An opening 303c is also formed between handles 303a, 303b. As is best seen in FIG. 3D, opening 303c extends from common base extension 303 on one side of teether 300 to proximal end 301a of base 301 on the opposite end. Openings 303a1, 303b1, and 303c enable a baby to easily grasp teether 300 via handles 303a, 303b while also providing access into the hollow interior formed by base 301 and biting structure 302.

Base 301 can also include a number of extensions 304 similar to extensions 104, 204. In particular, extensions 304 can function as a structure to prevent over-insertion of teether 300 into a baby's mouth and as supplemental biting structures. In the depicted embodiment, extensions 304 are configured to resemble leaves of a grape plant. Teether 300 can otherwise be configured in the same or similar manner as described above for teethers 100 and 200.

With regards to each of the above described and depicted embodiments, the distance to which proximal end 101a/201a/301a extends from distal end 101b/201b/301b can be varied to cause base 101/201/301 to also resemble leaves. The contour of the outer surface of base 101/201/301 can also be varied (e.g., by varying the thickness of the sidewall of base 101/201/301) to provide different levels of leaf-shaped structures as is best seen in FIGS. 1B, 1C, 2B, 2C, 3B, and 3C.

With specific reference to the cross-sections shown in FIGS. 1H, 2H, and 3H, base 101/201/301 and biting structure 102/202/302 together form a proximally-facing concave interior that is accessible via the corresponding openings. As shown, the sidewall of biting structure 102/202/302 can be relatively thin in comparison to the overall dimensions of teether 100/200/300 to thereby allow biting structure 102/202/302 to deform when bitten. In comparison, extensions 104/204/304 can be thicker than the sidewall of biting structure 102/202/302 such that extensions 104/204/304 provide a more rigid biting structure. Biting structure 102/202/302 and preferably the entirely of teether 100/200/300 can be formed of any deformable elastic material and may preferably be formed of FDA approved food grade silicone. In the depicted embodiment, biting structure 102/202/302 is molded as a separate component from base 101/201/301 and is then coupled to base 101/201/301 using any suitable coupling technique. This includes forming channels within distal end 101b/201b/301b into which proximal end 102a/202a/302a may insert. Any of the various known adhesives or welding techniques could then be employed to permanently secure biting structure 102/202/302 to base 101/201/301. Alternatively, in some embodiments, biting structure 102/202/302 and base 101/201/301 could be molded as a single component.

In summary, the present invention provides a teether design that forms a proximally-facing concave interior within a biting structure and base of the teether and that provides access to this hollow interior via openings formed within/between handles that extend proximally from the base. This design enables a baby to insert his or her fingers into/towards the mouth while simultaneously biting on the teether. The proximally-faced concave interior also facilitates cleaning the teether and prevents the growth of bacteria or other harmful organisms.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. A teether comprising:
a base having a proximal end and a distal end, the base having a hollow interior such that the proximal and distal ends of the base form openings into the hollow interior;
a biting structure that extends distally from the proximal end of the base, the biting structure having a proximal end coupled to the distal end of the base and an enclosed distal end, the biting structure forming a proximally-facing concave interior that is accessible via the hollow interior of the base; and
one or more handles that extend proximally from the proximal end of the base, each handle forming an opening by which the hollow interior of the base is accessible.

2. The teether of claim 1, further comprising:
extensions that emanate laterally from opposing sides of the base.

3. The teether of claim 2, wherein the extensions emanate laterally beyond lateral edges of the biting structure.

4. The teether of claim 3, wherein the extensions also emanate frontwardly and rearwardly beyond front and rear edges of the biting structure.

5. The teether of claim 2, wherein the extensions are configured in the shape of foliage.

6. The teether of claim 5, wherein the base is also configured with a contour that resembles foliage.

7. The teether of claim 1, wherein the biting structure is configured in the shape of a fruit.

8. The teether of claim 7, wherein the fruit is one of a strawberry, a pineapple, or grapes.

9. The teether of claim 7, wherein an outer surface of the biting structure includes protrusions that form a texture of the fruit.

10. The teether of claim 1, wherein an outer surface of the biting structure is tapered from the proximal end to the distal end of the biting structure.

11. The teether of claim 1, wherein the one or more handles comprise front and rear handles.

12. The teether of claim 11, wherein the handles emanate from a common base extension on each side of the base.

13. The teether of claim 11, wherein a first end of each handle emanates from a common base extension and a second end of each handle terminates at a middle portion of the corresponding front or rear side of the base.

14. The teether of claim 11, wherein the front handle has a first end that emanates from a first side of the base and a second end that terminates at a middle portion of the front of the base while the rear handle has a first end that emanates from a second side of the base, opposite the first side, and a second end that terminates at a middle portion of the rear of the base.

15. The teether of claim 11, wherein an opening is formed between the front and rear handles through which the hollow interior of the base is accessible.

16. The teether of claim 11, wherein the opening is defined by the front and rear handles and by one or more portions of the proximal end of the base.

17. A teether comprising:
a base having a hollow interior;
a biting structure that extends distally from the base, the biting structure forming a proximally-facing concave interior, the biting structure having an outer surface that is configured in the shape of a fruit; and
handles that extend proximally from the base, each handle forming an opening between the handle and a proximal end of the base by which the hollow interior of the base is accessible, the handles being configured to form an additional opening between the handles by which the hollow interior of the base is also accessible.

18. The teether of claim 17, wherein the base further includes extensions that emanate laterally beyond lateral edges of the biting structure.

19. A teether comprising:
a base having a proximal end, a distal end and a hollow interior, an outer surface of the base being configured to resemble foliage;
a biting structure that extends distally from the proximal end of the base, the biting structure forming a proximally-facing concave interior that is accessible via the hollow interior of the base, an outer surface of the biting structure being configured to resemble a fruit; and
one or more handles that extend proximally from the proximal end of the base.

20. The teether of claim 19, wherein the one or more handles comprise a front handle and a rear handle, the front handle forming a front opening between the front handle and the proximal end of the base, the rear handle forming a rear opening between the rear handle and the proximal end of the base, and the front and rear handles forming a central opening between the front and rear handles, each of the front opening, the rear opening, and the central opening providing access to the hollow interior of the base.
